(19) United States
(12) Patent Application Publication
(10) Pub. No.: US 2013/0072075 A1
(43) Pub. Date: Mar. 21, 2013

(54) CONDUCTIVE MEMBER AND METHOD OF MANUFACTURING THE SAME

(71) Applicant: Takashi Kayamoto, Isehara-shi (JP)

(72) Inventor: Takashi Kayamoto, Isehara-shi (JP)

(73) Assignee: NHK SPRING CO., LTD., Yokohama-shi (JP)

(21) Appl. No.: 13/642,624

(22) PCT Filed: Apr. 19, 2011
(86) PCT No.: PCT/JP2011/059659

§ 371 Date: Oct. 22, 2012

(30) Foreign Application Priority Data
Apr. 23, 2010 (JP) 2010-100356

(51) Int. Cl. H01R 13/02; H01R 43/16

(52) U.S. Cl. 439/887; 427/123

(57) ABSTRACT

Provided are a conductive member that is connectable to aluminum metal and can suppress a decrease in electrical conductivity, and a method of manufacturing the same. The conductive member is formed of aluminum or an alloy containing aluminum, and includes an electrical wire connection unit and a fastening unit, which are a base provided with a connection surface to be connected to another member, and a connection layer formed on the base by accelerating a powder of a metal or alloy, which has a lower ionization tendency than the base and has electrical conductivity equal to that of the base or higher, together with gas, and spraying and depositing the powder in the solid state on the connection surface.

### FIELD

The present invention relates to a conductive member used when an electrode, an electrical wire, and the like are electrically connected, and a method of manufacturing the same.

### BACKGROUND

Aluminum wire comprising aluminum or an aluminum alloy (hereinafter also referred to as aluminum metal) has conventionally been used as a power line at a power plant, on an overhead transmission line that sends electricity from a power plant to many places, and the like. Aluminum metal is superior in electrical conductivity, and is very light weight; accordingly, it is advantageous if an electrical wire is applied to a long electrical wire such as an overhead transmission line, and to a facility and equipment, which have many electrical wires.

On the other hand, copper and an alloy containing copper (hereinafter also referred to as copper metal), which have high electrical conductivity, are used as materials of electrical wire and a connection terminal for a power system of transport equipment such as a vehicle, a household electrical appliance, and the like. Although copper metal is very superior in electrical conductivity, it has a high specific gravity, which is approximately three times higher than aluminum. Therefore, it is being discussed to use aluminum metal as electrical wire and a connection terminal also for a vehicle, and the like to reduce the weight of a car. Especially, a power line having a large diameter becomes necessary for an electric vehicle and a fuel-cell vehicle, which have rapidly been developed and entered a commercialization stage, to extract a large amount of energy from a battery. Therefore, if a power line can be constructed of aluminum wire, a further decrease in the weight of a vehicle becomes possible.

However, aluminum metal has a characteristic that an oxide film will easily be formed on a surface. Therefore, if aluminum wires and connection terminals formed of aluminum metal are exposed in the air once, there arises a problem that the electrical resistance of a connection surface between the wire and the connection terminal, or between the connection terminals increases due to a surface oxide film. Therefore, it is being proposed to secure the electrical conductivity of the connection surface by connecting or covering copper metal that resists oxidization to and over the connection surface of aluminum metal. For example, Patent Literature 1 discloses that an intermediate cap made of a copper alloy covers a core wire made of aluminum, and a crimp section of an open barrel metal terminal made of a copper alloy is crimped so as to envelop the intermediate cap. Moreover, Patent Literature 2 discloses a terminal structure of an aluminum wire where a zinc (Zn) plating layer, a tin (Sn) plating layer or nickel (Ni) plating layer, and a copper (Cu) plating layer are successively laminated on a surface of a terminal portion of an aluminum core wire portion.

### CITATION LIST

### Patent Literature

Patent Literature 1: Japanese Patent Application Laid-open No. 2004-207172
Patent Literature 2: Japanese Patent Application Laid-open No. 2003-229192

### SUMMARY

### Technical Problem

As technologies for forming a composite member, in which different kinds of metals (or alloys) such as aluminum and copper are joined, soldering, welding, and the like are known. However, soldering to aluminum is very difficult; accordingly, two members do not come into close contact. Hence, electrical conductivity at the interface may decrease. Moreover, a flux contained in a solder makes a soldered part to corrode easily, and makes the electrical resistance of the interface between two members to increase. Also in the case of welding, it is difficult to bring two members of different kinds into close contact, and again, the electrical resistance of the interface increases.

Alternatively, a spray method of spraying a raw material (e.g., copper) that has been heated to high temperatures and melted on a base (e.g., aluminum) to form a coating is also known. However, in this case, the raw material oxidizes upon heating; accordingly, the electrical resistance of the film itself increases.

The present invention has been made considering the above, and an object thereof is to provide a conductive member that is connectable to aluminum metal and can suppress a decrease in electrical conductivity, and a method of manufacturing the same.

### Solution to Problem

To solve the problem described above and achieve the object, a conductive member according to the present invention includes: a base formed of aluminum (Al) or an alloy containing aluminum, the base being provided with a connection surface to be connected to another member; and a connection layer formed on the base by accelerating a powder of a metal or alloy, which has a lower ionization tendency than the base and has electrical conductivity equal to that of the base or higher, together with gas, and spraying and depositing the powder in a solid state on the connection surface.

In the conductive member according to the present invention as set forth in the invention described above, the connection layer is formed of any one of metals of copper (Cu), silver (Ag), and gold (Au), or an alloy containing any one of the metals.

In the conductive member according to the present invention as set forth in the invention described above, further provided is a coating layer formed around a perimeter of an interface between the base and the connection layer by accelerating a powder of any one of metals of nickel (Ni), zinc (Zn), tin (Sn), and titanium (Ti), or of an alloy containing any one of the metals together with gas, and spraying and depositing the powder in a solid state around the perimeter of the interface.

In the conductive member according to the present invention as set forth in the invention described above, the base includes a middle layer where a powder of any one of metals of nickel (Ni), zinc (Zn), tin (Sn), and titanium (Ti), or of an alloy containing any one of the metals is accelerated together with gas to be sprayed and deposited on the aluminum or aluminum alloy while in a solid state, the middle layer forming the connection surface.

In the conductive member according to the present invention as set forth in the invention described above, the base includes: an electrical wire connection unit to which an electrical wire is connected, and a fastening unit connected to the electrical wire connection unit and provided with the connection surface.

In the conductive member according to the present invention as set forth in the invention described above, the base is an electrical wire whose own end face is set as the connection surface.

In the conductive member according to the present invention as set forth in the invention described above, the base is an electrical wire whose own end side surface is set as the connection surface.

A method of manufacturing a conductive member according to the present invention includes: a base forming step of forming a base formed of aluminum (Al) or an alloy containing aluminum, the base including a connection surface to be connected to another member; and a connection layer forming step of forming a connection layer on the base by accelerating a powder of a metal or alloy, which has a lower ionization tendency than the base and has electrical conductivity equal to that of the base or higher, together with gas, and spraying and depositing the powder in a solid state on the connection surface.

In the method of manufacturing a conductive member according to the present invention as set forth in the invention described above, the powder comprises any one of metals of copper (Cu), silver (Ag), and gold (Au), or an alloy containing any one of the metals.

In the method of manufacturing a conductive member according to the present invention as set forth in the invention described above, further provided is a coating layer forming step of forming a coating layer around a perimeter of an interface between the base and the connection layer by accelerating a powder of any one of metals of nickel (Ni), zinc (Zn), tin (Sn), and titanium (Ti), or of an alloy containing any one of the metals together with gas, and spraying and depositing the powder in a solid state around the perimeter of the interface.

In the method of manufacturing a conductive member according to the present invention as set forth in the invention described above, the base forming step includes depositing a middle layer forming the connection surface by accelerating a powder of any one of metals of nickel (Ni), zinc (Zn), tin (Sn), and titanium (Ti), or of an alloy containing any one of the metals together with gas, and spraying the powder in a solid state on the aluminum or aluminum alloy.

### Advantageous Effects of Invention

According to the present invention, a powder of a metal or alloy having a lower ionization tendency than a base formed of aluminum metal and having electrical conductivity equal to that of the base or higher is sprayed on a connection surface of the base to form a compact connection layer in close contact with a lower layer. Accordingly, it is possible to suppress the formation of a surface oxide film on a contact surface with another member, and suppress a decrease in electrical conductivity at the interface between the base and the connection layer, and in the connection layer.

### BRIEF DESCRIPTION OF DRAWINGS

FIG. 1A is a perspective view illustrating a conductive member according to a first embodiment of the present invention.

FIG. 1B is a cross-sectional view taken along A-A of FIG. 1A.

FIG. 2A is a view explaining a method of connecting a cable to a connection member illustrated in FIG. 1.

FIG. 2B is a view illustrating the connection member to which the cable is connected.

FIG. 3 is a perspective view illustrating an aspect of the use of the connection member illustrated in FIG. 1.

FIG. 4A is a view explaining a method of manufacturing the connection member illustrated in FIG. 1.

FIG. 4B is a view illustrating the state where a connection layer is formed on a fastening unit.

FIG. 4C is a view illustrating the state of connecting an electrical wire connection unit to the fastening unit.

FIG. 5 is a schematic drawing illustrating the configuration of a film deposition apparatus using cold spray.

FIG. 6 is a cross-sectional view illustrating Modification 1 of the connection member illustrated in FIG. 1.

FIG. 7 is a cross-sectional view illustrating Modification 2 of the connection member illustrated in FIG. 1.

FIG. 8 is a perspective view illustrating a conductive member according to a second embodiment of the present invention.

FIG. 9 is a view explaining a method of forming the end structure of the electrical wire illustrated in FIG. 8.

FIG. 10A is a view explaining a method of connecting the electrical wire illustrated in FIG. 8 to a connection member.

FIG. 10B is a perspective view illustrating the electrical wire connected to the connection member.

FIG. 11 is a perspective view illustrating Modification 1 of the end structure of the electrical wire illustrated in FIG. 8.

FIG. 12 is a view explaining a method of forming the end structure of the electrical wire illustrated in FIG. 11.

FIG. 13 is a perspective view illustrating Modification 2 of the end structure of the electrical wire illustrated in FIG. 8.

FIG. 14 is a perspective view illustrating a conductive member according to a third embodiment of the present invention.

FIG. 15A is a view explaining a method of connecting the electrical wire illustrated in FIG. 14 to a connection member.

FIG. 15B is a perspective view illustrating the electrical wire connected to the connection member.

FIG. 16 is a perspective view illustrating Modification 1 of the end structure of the electrical wire illustrated in FIG. 14.

FIG. 17 is a view explaining a method of forming the end structure of the electrical wire illustrated in FIG. 16.

FIG. 18 is a perspective view illustrating Modification 2 of the end structure of the electrical wire illustrated in FIG. 14.

### DESCRIPTION OF EMBODIMENTS

A detailed description will hereinafter be given of embodiments of a conductive member and a method of manufacturing the same according to the present invention with reference to the drawings. The present invention is not limited by the following embodiments.

### First Embodiment

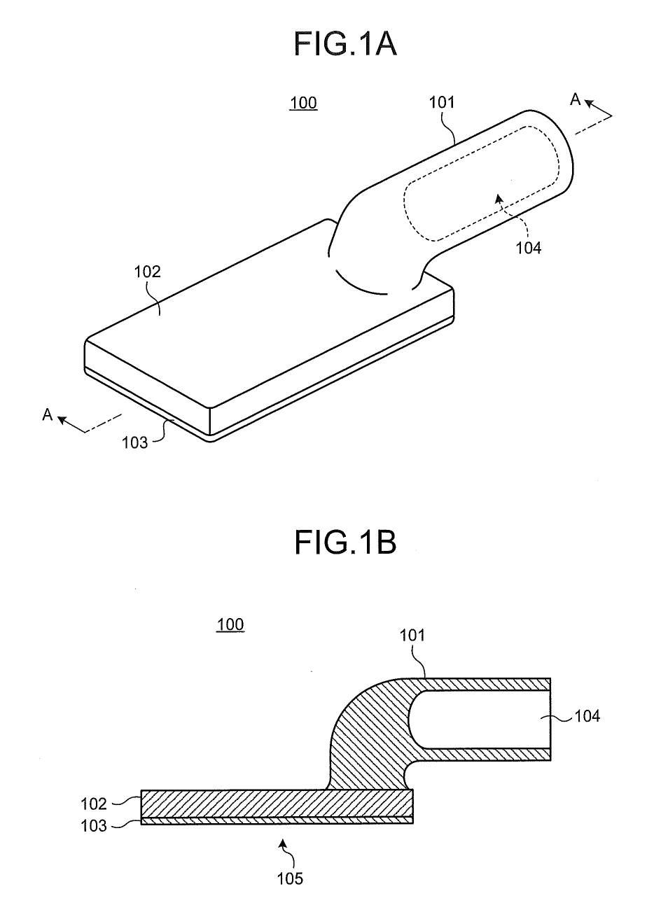

FIG. 1A is a perspective view illustrating an appearance of a conductive member according to a first embodiment of the present invention. Moreover, FIG. 1B is a cross-sectional view taken along line A-A of FIG. 1A. A connection member 100 being a conductive member according to the first embodiment is a member used when an electrical wire is connected to another connection member (a connection terminal, electrode, or the like) and includes an electrical wire connection unit 101 and a fastening unit 102, which are a base formed of aluminum (Al) or an aluminum alloy (hereinafter also referred to as aluminum metal), and a connection layer 103 formed on the fastening unit 102. In the first embodiment, the base is formed of aluminum.

The electrical wire connection unit 101 is a cylindrical member provided with an insertion hole 104 having, for example, a diameter of approximately 2 cm at one end, into which an electrical wire being a connection target is inserted. Moreover, the other end of the electrical wire connection unit 101 has a curved shape.

The fastening unit 102 is a plate-shaped member having, for example, a long side of approximately 8 cm, and a short side of approximately 2 cm, including a connection surface 105 to be connected to another connection member. On a main surface opposite to the connection surface 105 of the fastening unit 102, the electrical wire connection unit 101 is electrically and mechanically connected by electron beam welding, soldering, or the like. The electrical wire connection unit 101 and the fastening unit 102 may be integrally formed.

The electrical wire connection unit 101 and the fastening unit 102 are formed into these shapes to support an electrical wire to be connected to the electrical wire connection unit 101 in parallel with the connection surface 105.

The connection layer 103 is formed of a metal or alloy having a lower ionization tendency than the aluminum metal forming the fastening unit 102, and having electrical conductivity equal to that of the aluminum metal or higher. The connection layer 103 is provided to prevent the formation of an oxide film on the connection surface 105 of the fastening unit 102 and suppress a decrease in electrical connectivity to a connection target (another connection member). Specifically, examples of a material of the connection layer 103 include copper (Cu) or an alloy containing copper, silver (Ag) or an alloy containing silver, and gold (Au) or an alloy containing gold, and copper is used in the first embodiment. Moreover, the thickness of the connection layer 103 is not specially limited, but preferably approximately 0.1 mm to 10 mm, and more preferably approximately 1 mm to 5 mm.

The connection layer 103 is formed by accelerating a copper powder being a material of this layer together with gas to high velocities, and spraying and depositing the powder, which in the solid state, on the connection surface 105. Such a method of forming a layer (film deposition method) is called cold spray. The connection layer 103 formed by cold spray has the following characteristics.

In cold spray, a metal powder impacts and erodes a surface of a lower layer (a surface of the fastening unit 102 and the theretofore deposited connection layer 103) at high velocities, and deforms itself to adhere to the lower layer; accordingly, a layer in strong contact with the lower layer is formed. This can be seen from a fact that a phenomenon that the connection layer 103 erodes the fastening unit 102 (called the anchor effect) is observed at the interface between the connection layer 103 and the fastening unit 102. In other words, the connection layer 103 is strongly connected to the surface of the fastening unit 102 without gaps. Accordingly, there are few possibilities that electrical conductivity decreases at the interface between the connection layer 103 and the fastening unit 102, and there are hardly any possibilities that the connection layer 103 comes off the fastening unit 102, either.

Moreover, since a layer is formed as described above, the connection layer 103 itself is also a very compact layer, and has a density of 95% or more compared with a copper bulk material, for example. Furthermore, in cold spray, a metal powder is heated only to a level that can maintain the solid state of the powder. Therefore, the oxidization of the powder is suppressed. Therefore, the electrical conductivity of the connection layer 103 itself has the characteristic of 90% or more compared with a bulk material. The method of forming the connection layer 103 by cold spray will be described in detail later.

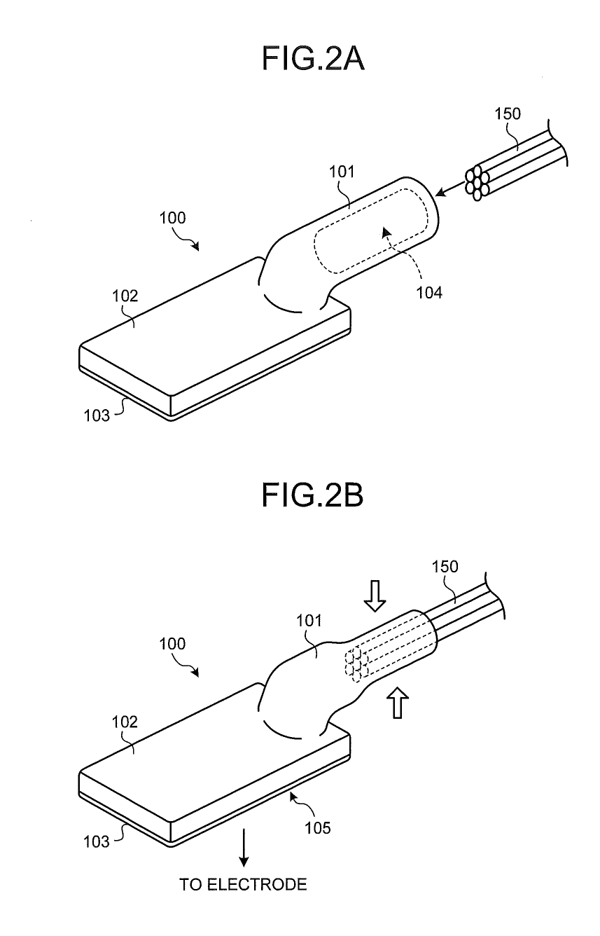

FIGS. 2A and 2B are views explaining a method of using the connection member 100 illustrated in FIG. 1. Firstly, as illustrated in FIG. 2A, an end of an aluminum metal electrical wire 150 is inserted into the insertion hole 104 provided to the electrical wire connection unit 101. The electrical wire 150 may be multiple wires as illustrated in FIG. 2A, or may be a solid wire or stranded wire. As illustrated in FIG. 2B, the electrical wire connection unit 101 is crimped to electrically and mechanically connect the connection member 100 and the electrical wire 150.

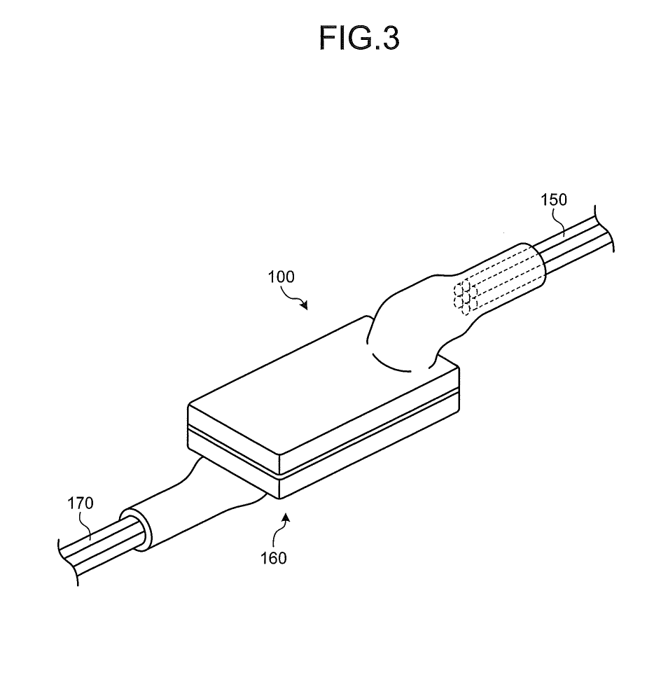

Such a connection member 100 is used when electrical wires are connected as illustrated in FIG. 3, for example. In other words, an electrical wire 170 to which a connection member 160 has been connected at an end is prepared to bring the connection surfaces of the connection members 100 and 160 into contact and connect them by crimping, bolting, soldering, or the like. The connection member 160 and the electrical wire 170 may be formed of the same materials of the connection member 100 and the electrical wire 150, or may be a general connection member and electrical wire, which are formed of copper or an alloy containing copper.

Moreover, if the electrical wire 150 is connected to an electrode, the connection surface 105 of the connection member 100, which is illustrated in FIG. 2B, is brought into contact with the electrode to connect them by bolting, soldering or the like. A general electrode formed of copper or an alloy containing copper will serve as an electrode being a connection target.

As described above, according to the first embodiment, because the connection layer 103 is formed of copper or the like on the connection surface 105 of the fastening unit 102 formed of aluminum metal, it is possible to suppress a decrease in electrical connectivity at the interface between the connection layer 103 and a connection target. Moreover, because the connection layer 103 is formed by cold spray, it is also possible to suppress a decrease in electrical connectivity at the interface between the base and the connection layer 103, and in the connection layer 103. Hence, the use of such a connection member 100 makes it possible to connect an electrical wire formed of aluminum metal to a general connection member, electrode, or the like, which is formed of copper or the like, readily and with excellent electrical connectivity.

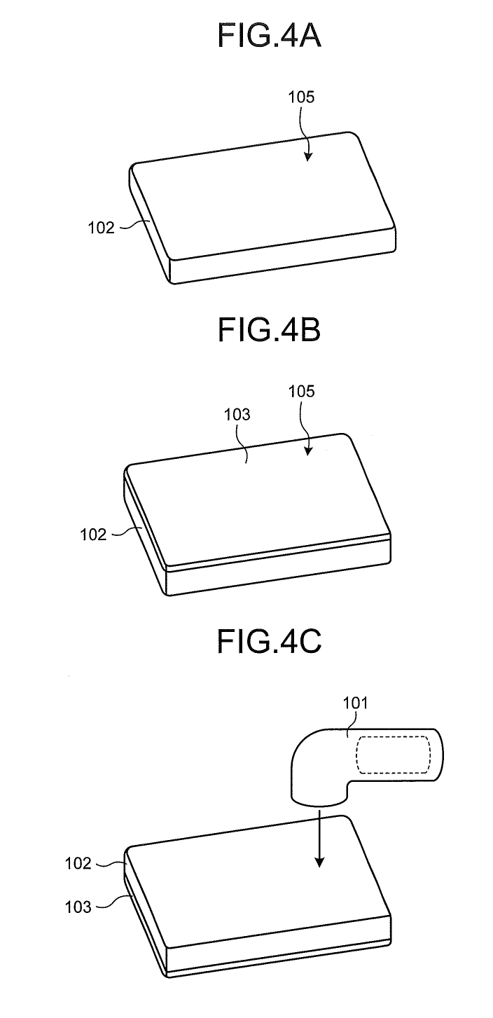

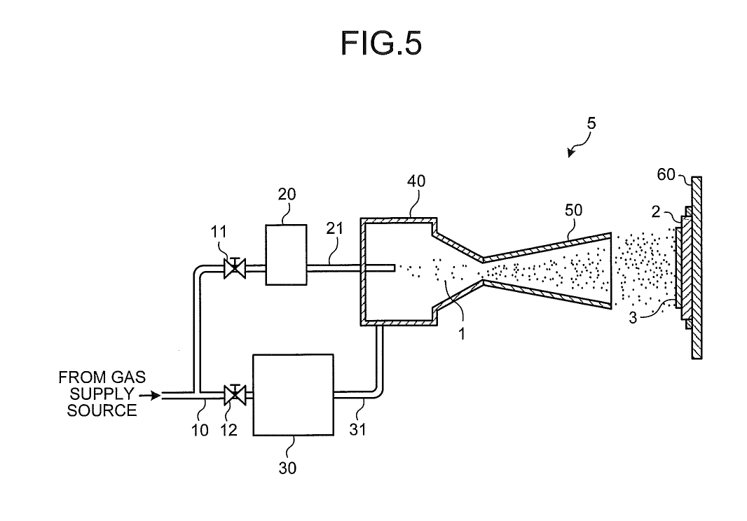

Next, a description will be given of a method of manufacturing the conductive member according to the first embodiment with reference to FIGS. 4A to 4C and FIG. 5.

Firstly, as illustrated in FIG. 4A, a base including the connection surface 105 on which the connection layer 103 is formed is formed. In the first embodiment, an aluminum metal is cut into the shape of the fastening unit 102 and the connection surface 105 side is ground, so that a surface oxide film is removed.

Next, as illustrated in FIG. 4B, the connection layer 103 is formed on the connection surface 105 of the fastening unit 102 by cold spray.

FIG. 5 is a schematic drawing illustrating the configuration of a film deposition apparatus using cold spray. This film deposition apparatus 5 includes a gas introduction tube 10 that introduces inert gases such as helium (He) and nitrogen (N₂), and gases (working gases) such as air from a gas supply source, a powder feed unit 20 that feeds a metal or alloy powder 1 being a raw material, a heater 30 that heats the gas introduced from the gas introduction tube 10 to a desired temperature, a chamber 40 that mixes and jets the powder 1 and the gas, a nozzle 50 that jets the powder 1 to a substrate 2, and a holder 60 that holds the substrate 2.

The minute powder 1 of the raw material (for example, the diameter of the particle is approximately 10 μm to 100 μm) is placed in the powder feed unit 20. A valve 11 provided to the gas introduction tube 10 is operated to introduce the gas at a desired flow rate into the powder feed unit 20; accordingly, the powder 1, together with the gas, is fed to the chamber 40 through a powder feed tube 21.

The heater 30 heats the introduced gas to approximately 50° C. to 700° C., for example. The upper limit of the heating temperature is set to be less than the melting point of the raw material to spray the powder 1 in the solid state on the substrate 2. More preferably, the upper limit temperature is maintained at approximately 60% or lower of the melting point in Celsius. This is because as the heating temperature increases, the possibility of oxidization of the powder 1 increases. Hence, for example, if a film of copper (melting point: approximately 1083° C.) is formed, the heating point is set to less than approximately 1083° C., and more preferably approximately 650° C. or lower.

The gas heated in the heater 30 is introduced into the chamber 40 via a tube for gas 31. The flow rate of gas introduced into the chamber 40 is adjusted by operating a valve 12 provided to the gas introduction tube 10.

The flow of gas from the nozzle 50 to the substrate 2 is formed in the chamber 40 by the gas introduced from the tube for gas 31. If the powder 1 is fed from the powder feed unit 20 to the chamber 40, the powder 1 is entrained in the gas to be accelerated and heated, and is sprayed on the substrate 2 from the nozzle 50. The impact at this time makes the powder 1 to erode the substrate 2. The powder 1 experiences plastic deformation due to kinetic energy or thermal energy that the powder 1 has, and adheres to the substrate 2, so that a film 3 is formed.

The velocity to accelerate the powder 1, in other words, the velocity of flow of gas of when jetted from the nozzle 50 is supersonic (approximately 340 m/s or more), and is preferably set to approximately 400 m/s or more, for example. The velocity can be controlled by operating the valve 12 and adjusting the flow rate of the gas to be introduced into the chamber 40. Moreover, similarly to the film deposition apparatus 5, the use of the nozzle 50 whose diameter expands in a taper shape from a proximal end to a distal end makes it possible to narrow the flow of gas, which has been formed in the chamber 40, at the entrance of the nozzle 50 once, and accelerate the flow.

Upon formation of the connection layer 103 illustrated in FIG. 4B, a metal powder is charged into the powder feed unit 20, and the base (the fastening unit 102), instead of the substrate 2, is set on the holder 60 such that the connection surface 105 side faces an injection port of the nozzle 50. A film is then deposited. If the diameter of the nozzle 50 is small relative to the connection surface 105, the nozzle 50 is moved over the connection surface 105 to successively form a film. Alternatively, the position of the nozzle 50 may be fixed, and the holder 60 side may be made movable.

Furthermore, after the film deposition, the top of the connection layer 103 and the side surface of the fastening unit 102 may be ground and cut to smooth the surfaces.

Next, as illustrated in FIG. 4C, the electrical wire connection unit 101, which has been previously manufactured, is joined to a surface opposite to the connection layer 103 of the fastening unit 102 by electron beam welding, soldering, or the like. The electrical wire connection unit 101 and the fastening unit 102 are formed of metals of the same kind; accordingly, it is possible to readily join them without impairing the electrical conductivity at the interface due to welding, soldering, or the like. Consequently, the connection member 100 illustrated in FIG. 1 is manufactured.

In the above description, the connection layer 103 is formed on the connection surface 105 of the fastening unit 102. The electrical wire connection unit 101 is subsequently joined to the fastening unit 102. However, the connection layer 103 may be formed on the connection surface 105 after the electrical wire connection unit 101 is joined to the fastening unit 102 first, or they may be integrally formed.

Moreover, in the above description, the fastening unit 102 is manufactured and then the connection layer 103 is formed on the connection surface 105. However, after the connection layer 103 is formed on a plate-shaped member, the member may be cut into the size of the fastening unit 102.

Furthermore, in the above description, the electrical wire connection unit provided with the insertion hole into which an electrical wire is inserted and the connection member including the rectangular fastening unit have been described; however, the shape of the connection member is not specially limited. In other words, the first embodiment can be applied to connection members having various shapes such as a compression terminal having a hole for bolting formed in the fastening unit, a ring tongue solderless terminal having a round hole, a spade tongue solderless terminal whose end is open, and an open-barrel or closed-barrel solderless terminal.

Moreover, with respect to the size of the connection member, it is possible to apply the first embodiment widely from a connection member for an electrical wire whose diameter is 1 mm or smaller to a connection member for an electrical wire whose diameter is 300 mm or larger. If an electrode member of a small size (for example, one side of the connection surface is 2 cm or shorter) is manufactured, it is desirable that the connection layer should be formed by cold spray on a plate-shaped aluminum metal member to subsequently cut out and process the fastening unit (the fastening unit and the electrical wire connection unit in the case of integral formation). Moreover, with respect to a connection member of a type that the fastening unit is connected to another connection member with a bolt, it is desirable to form a coating of copper or the like using cold spray not only on the connection surface that comes in a direct contact with a connection target, but also on an opposite surface with which a washer comes into contact, and a side surface with which the bolt comes into contact.

Furthermore, the first embodiment can be applied to a busbar (also referred to as a bus bar) being a metal plate placed as a power supply line and the like. In this case, the entire busbar is formed of aluminum metal, and a coating of copper or the like is formed by cold spray on a connection part with another member (a terminal of a bus, through-hole, pin connector, or the like).

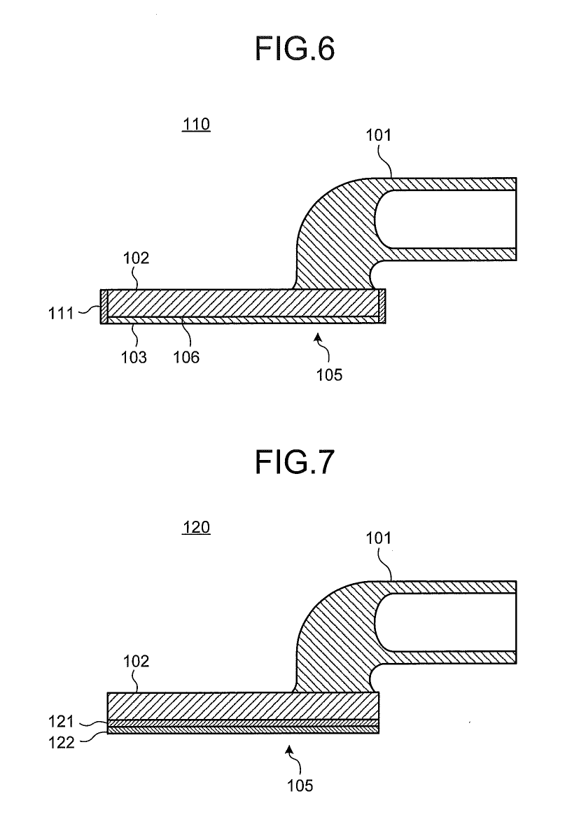

Next, a description will be given of Modification 1 of the conductive member according to the first embodiment. FIG. 6 is a cross-sectional view illustrating a conductive member according to Modification 1.

A connection member 110 being Modification 1 includes a coating layer 111 formed on side surfaces of the fastening unit 102 and the connection layer 103. The other configurations are similar to those illustrated in FIG. 1.

Generally, if metals having a large difference in standard electrode potentials, such as aluminum and copper, are left in direct contact, it may cause electrolytic corrosion that the metals react with moisture in the air and corrode due to an electrochemical reaction. Therefore, in Modification 1, the coating layer 111 covers the perimeter of an interface 106 between the fastening unit 102 formed of aluminum and the connection layer 103 formed of copper to shield the interface 106 from the ambient air. It is sufficient if the thickness of the coating layer 111 is, for example, approximately 50 μm or more.

Used as a material of the coating layer 111 is a metal or alloy having a lower ionization tendency than the fastening unit 102 and a higher ionization tendency than the connection layer 103. More preferably, used is a material whose standard electrode potential is substantially in the middle between the standard electrode potentials of the fastening unit 102 and the connection layer 103. If such a metal or alloy is used, the differences in standard electrode potentials between the fastening unit 102 and the coating layer 111, and between the connection layer 103 and the coating layer 111 are reduced, and therefore electrolytic corrosion hardly occurs at their interfaces. Specifically, in the case where the fastening unit 102 is made of aluminum and the connection layer 103 is made of copper, zinc (Zn) or an alloy containing zinc, nickel (Ni) or an alloy containing nickel, or tin (Sn) or an alloy containing tin is used as the coating layer 111.

Alternatively, titanium (Ti) or an alloy containing titanium may be used as a material of the coating layer 111. This is because titanium forms a compact oxide film (passivation film) on a surface, and accordingly, even if in contact with a different kind of metal, there are hardly any possibilities of electrolytic corrosion.

The coating layer 111 is preferably formed by cold spray with the film deposition apparatus 5. Specifically, for example, a tin powder is charged into the powder feed unit 20, and the fastening unit 102 on which the connection layer 103 has been formed is set on the holder 60 such that a side surface thereof faces the injection port of the nozzle 50. Tin coatings are then formed on all of the four side surfaces. The melting point of tin is approximately 230° C.; accordingly, if a coating is formed, the temperature of gas is set to less than 230° C., and preferably less than approximately 138° C. According to such cold spray, a compact film in close contact with the lower layer (the side surfaces of the fastening unit 102 and the connection layer 103) can be formed; accordingly, it is possible to obtain a shielding effect from the air even if the coating layer 111 is not made so thick.

Next, a description will be given of Modification 2 of the conductive member according to the first embodiment. FIG. 7 is a cross-sectional view illustrating a conductive member according to Modification 2.

A connection member 120 being Modification 2 includes a middle layer 121 formed on the connection surface 105 of the fastening unit 102 and a connection layer 122 formed on the middle layer 121. The other configurations are similar to those illustrated in FIG. 1.

Similarly to the first embodiment, the connection layer 122 is provided to prevent the formation of an oxide film on the connection surface 105 of the fastening unit 102 and suppress a decrease in electrical connectivity to another connection member. On the other hand, the middle layer 121 is a layer having a thickness of approximately 0.1 mm to 1 mm, which is formed to suppress electrolytic corrosion between the aluminum fastening unit 102 and the copper connection layer 122.

Used as a material of the middle layer 121 is a metal or alloy having an ionization tendency between that of the fastening unit 102 and that of the connection layer 122, such as zinc, nickel, and tin. Consequently, the differences in standard electrode potentials between the fastening unit 102 and the middle layer 121 and between the middle layer 121 and the connection layer 122 are reduced, and therefore it is possible suppress the occurrence of an electrochemical reaction. As a material of the middle layer 121, a material that resists electrolytic corrosion, such as titanium, may be used.

Such a middle layer 121 and connection layer 122 are formed by cold spray with the film deposition apparatus 5. Specifically, firstly, for example, a tin powder is charged as a material of the middle layer 121 into the powder feed unit 20, and the fastening unit 102 is set on the holder 60. Film deposition is then started to deposit the middle layer 121 forming a connection surface on the fastening unit 102. Next, the contents of the powder feed unit 20 are replaced with a copper powder to deposit a film; accordingly, the connection layer 122 is formed on the middle layer 121.

According to such cold spray, it is possible to form a compact film in close contact with a surface being a spray target. Accordingly, electrical resistance is not significantly increased at the interface between the fastening unit 102 and the middle layer 121, in the middle layer 121, and at the interface between the middle layer 121 and the connection layer 122, either, and it is possible to secure excellent electrical conductivity.

### Second Embodiment

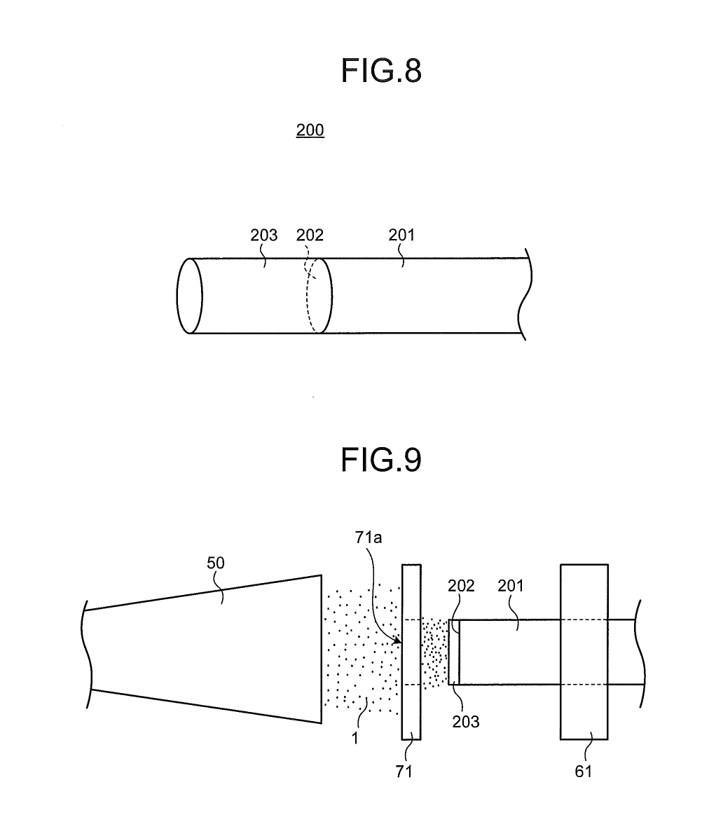

Next, a description will be given of a conductive member according to a second embodiment of the present invention. FIG. 8 is a perspective view illustrating the conductive member according to the second embodiment.

An end structure 200 of an electrical wire being the conductive member according to the second embodiment includes an electrical wire 201 being a base formed of aluminum metal and a connection layer 203 formed on an end face 202 being a connection surface of the electrical wire 201 and a connection target (a connection member, or the like).

Since the connection layer 203 is formed on the end face 202 of the electrical wire 201 as will be described later, the diameter of the electrical wire 201 is preferably approximately 2 mm or more, and is set to approximately 10 mm in the second embodiment. Moreover, the electrical wire 201 is shown as a solid wire in FIG. 8, but may be a stranded wire that a plurality of aluminum wires are stranded. Moreover, an area other than an end of the electrical wire 201 may be covered with a jacket or the like.

The connection layer 203 is formed of a metal or alloy having a lower ionization tendency than aluminum metal forming the electrical wire 201, and electrical conductivity equal to that of aluminum metal or higher. The connection layer 203 is provided to prevent the formation of an oxide film on the end face 202 forming a connection surface of the electrical wire 201 and suppress a decrease in electrical connectivity between the electrical wire 201 and a connection target. Therefore, it is sufficient if the thickness of the connection layer 203 (the size in a lengthwise direction of the electrical wire 201) is equal to a contact area with the connection target or more. Moreover, specific examples of a material of the connection layer 203 include copper (Cu) or an alloy containing copper, silver (Ag) or an alloy containing silver, and gold (Au) or an alloy containing gold, and copper is used in the second embodiment.

Such an end structure 200 of the electrical wire is formed as follows. Firstly, a preparation is made to form the connection layer 203 at an end of the electrical wire 201. For example, if the electrical wire 201 is a bare wire, it is desirable that the end face 202 is subjected to grinding and the like to remove a surface oxide film. At that time, the shape of the end face 202 is preferably formed such that the end face 202 is orthogonal to the lengthwise direction of the electrical wire 201. Moreover, if the electrical wire 201 is an insulated wire, a cladding material of the end is removed in advance.

Next, a copper powder being the material is accelerated to high velocities to be sprayed and deposited on the end face 202 of the electrical wire 201 while in the solid state. Accordingly, the connection layer 203 is formed on the end face 202. Specifically, in the film deposition apparatus 5, a holder 61 illustrated in FIG. 9 is placed instead of the holder 60, and the electrical wire 201 is set such that the end face 202 faces the injection port of the nozzle 50. Moreover, a mask 71 provided with an opening 71a is placed in front of the electrical wire 201 to prevent a film from adhering to an area other than the end face 202 of the electrical wire 201. The copper powder 1 being the material of the connection layer 203 is then charged into the powder feed unit 20 to start film deposition. Consequently, the powder 1 is jetted from the nozzle 50 to be deposited on the end face 202 of the electrical wire 201, and the copper connection layer 203 is formed. An end face of the connection layer 203 and a side surface of the electrical wire 201 may be subsequently subjected to grinding and the like to smooth their surfaces, or remove copper adhered to an unnecessary area.

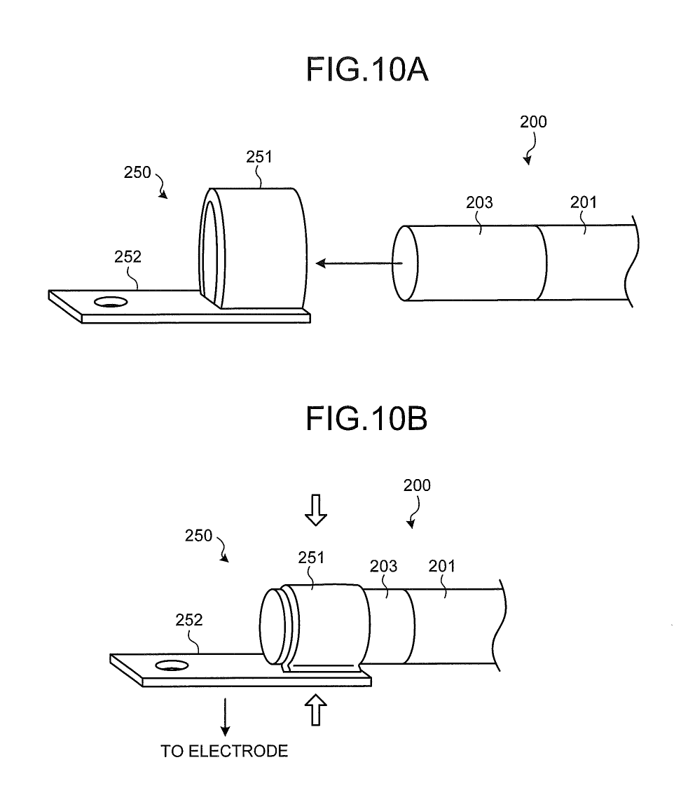

The electrical wire having such an end structure 200 is used as follows. That is, as illustrated in FIG. 10A, a general connection member 250 formed of copper or the like, including an electrode connection unit 251 and a fastening unit 252, is prepared to insert a part of the connection layer 203 of the electrical wire into the electrode connection unit 251. As illustrated in FIG. 10B, the electrode connection unit 251 is then crimped to electrically and mechanically connect the connection layer 203 and the electrode connection unit 251. Next, the fastening unit 252 is connected by a bolt, soldering, or the like to an electrode of a desired facility or apparatus.

As described above, according to the second embodiment, because the connection layer 203 is formed of copper or the like on the end face 202 of the aluminum metal electrical wire 201, it is possible to suppress a decrease in electrical conductivity at the interface with a connection target. Moreover, because the connection layer 203 is formed by cold spray, the end face 202 of the electrical wire 201 and the connection layer 203 are in strong contact due to the anchor effect, and the connection layer 203 itself is also very compact. Therefore, it is possible to suppress a decrease in electrical conductivity also at the end face 202 and in the connection layer 203. Furthermore, the use of cold spray makes it possible to have a desired thickness for the connection layer 203. Hence, the use of such an end structure makes it possible to connect an aluminum metal electrical wire to a general electrode or connection member formed of copper or the like with excellent electrical connectivity.

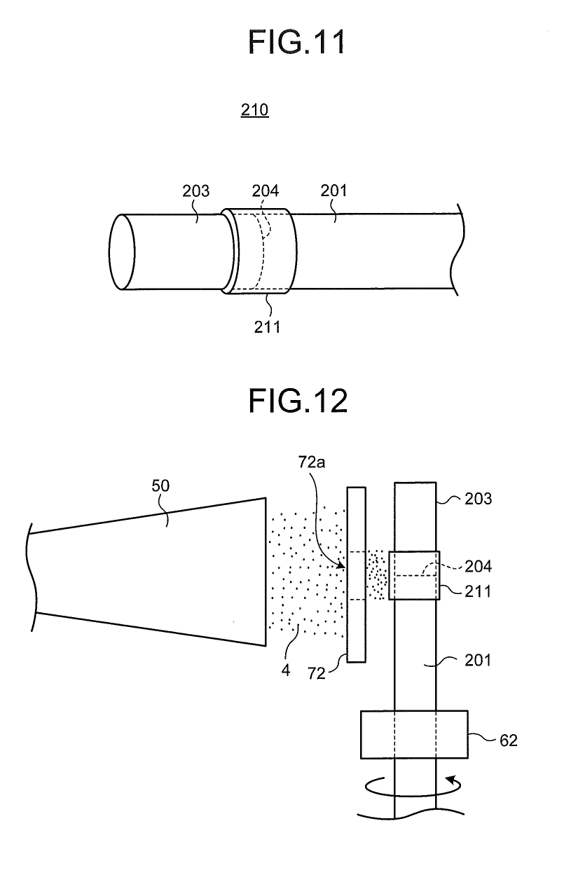

Next, a description will be given of Modification 1 of the conductive member according to the second embodiment. FIG. 11 is a perspective view illustrating a conductive member according to Modification 1.

An end structure 210 of the electrical wire being Modification 1 includes a coating layer 211 formed so as to cover the perimeter of an interface 204 between the electrical wire 201 and the connection layer 203. The other configurations are similar to those illustrated in FIG. 8.

As described above, if aluminum metal and copper are left in direct contact, electrolytic corrosion may occur. Therefore, in Modification 1, the perimeter of the interface 204 between the electrical wire 201 and the connection layer 203 is covered with the coating layer 211 to shield the interface 204 from the ambient air. It is sufficient if the thickness of the coating layer 211 is, for example, approximately 50 μm or more.

Used as a material of the coating layer 211 is a metal or alloy having a lower ionization tendency than the electrical wire 201 and a higher ionization tendency than the connection layer 203, such as zinc, nickel, and tin. Alternatively, a metal or alloy that resists electrolytic corrosion due to the formation of a compact oxide film on a surface, such as titanium, may be used.

It is desirable to form the coating layer 211 by cold spray. Specifically, in the film deposition apparatus 5, a rotatable holder 62 illustrated in FIG. 12 is placed instead of the holder 60 such that a direction orthogonal to the axis of the nozzle 50 is set as the rotation axis. The electrical wire 201 is then set on the holder 62 such that an area including a boundary between the electrical wire 201 and the connection layer 203 faces the injection port of the nozzle 50. Furthermore, a mask 72 provided with an opening 72a is placed in front of the electrical wire 201 to prevent a film from adhering to an unnecessary area. For example, a tin powder is then charged as a material of the coating layer 211 into the powder feed unit 20, and film deposition starts by rotating the holder 62. Consequently, a powder 4 is jetted from the nozzle 50 to form the tin coating layer 211 in a manner of covering the perimeter of the interface 204.

In this manner, according to cold spray, a compact film in close contact with a lower layer (side surfaces of the electrical wire 201 and the connection layer 203) can be formed; accordingly, it is possible to obtain a shielding effect from the air even if the thickness of the coating layer 211 is not made so thick. Moreover, the use of the mask makes it possible to form a coating at a desired position; accordingly, it is possible to form the coating layer 211 only around the perimeter of the interface 204, and expose a part of the connection layer 203, which is connected to an electrode, connection member, or the like.

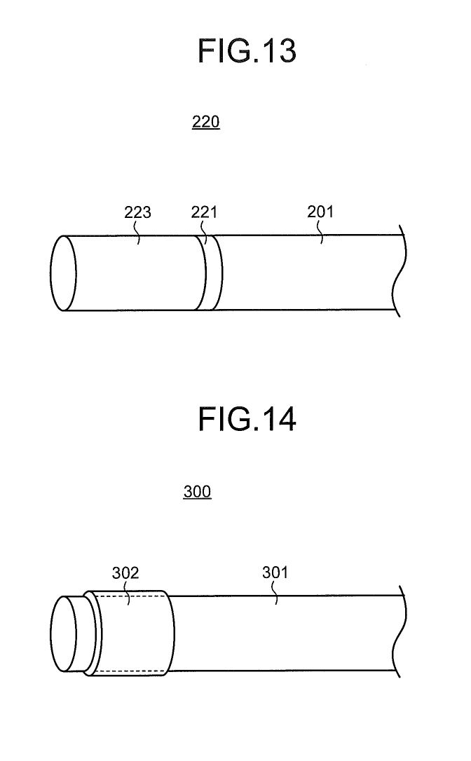

Next, a description will be given of Modification 2 of the conductive member according to the second embodiment. FIG. 13 is a perspective view illustrating a conductive member according to Modification 2.

An end structure 220 of the electrical wire being Modification 2 includes a middle layer 221 formed on the end face 202 of the electrical wire 201 and a connection layer 223 formed on the middle layer 221. The other configurations are similar to those illustrated in FIG. 8.

Similarly to the second embodiment, the connection layer 223 is provided to prevent the formation of an oxide film on a connection surface of the electrical wire 201 and suppress a decrease in electrical connectivity to a connection target. On the other hand, the middle layer 221 is a layer having a thickness of approximately 0.5 mm, which is formed to suppress electrolytic corrosion between the aluminum electrical wire 201 and the copper connection layer 223.

Used as a material of the middle layer 221 is a metal or alloy having a lower ionization tendency than the electrical wire 201 and a higher ionization tendency than the connection layer 223, such as zinc, nickel, and tin. Alternatively, a metal or alloy that resists electrolytic corrosion due to the formation of a compact oxide film on a surface, such as titanium, may be used.

The end structure 220 of the electrical wire including such a middle layer 221 is formed by cold spray. Specifically, in the film deposition apparatus 5, firstly, the electrical wire 201 is set on the holder 61, and the mask 71 is placed, similarly to FIG. 9. For example, a tin powder is then charged as a material of the middle layer into the powder feed unit 20 to start film deposition; accordingly, the middle layer 221 forming the connection surface is deposited on the end face 202 of the electrical wire 201. Next, the contents of the powder feed unit 20 are replaced with a copper powder to deposit a film; accordingly, the connection layer 223 is formed on the middle layer 221.

According to such cold spray, it is possible to form a compact film in close contact with the lower layer. Accordingly, electrical resistance is not significantly increased at the interface between the electrical wire 201 and the middle layer 221, in the middle layer 221, and at the interface between the middle layer 221 and the connection layer 223, either, and it is possible to secure excellent electrical conductivity.

### Third Embodiment

Next, a description will be given of a conductive member according to a third embodiment of the present invention. FIG. 14 is a perspective view of the conductive member according to the third embodiment.

An end structure 300 of the electrical wire being the conductive member according to the third embodiment includes an electrical wire 301 being a base formed of aluminum metal, and a connection layer 302 formed on a side surface in the vicinity of an end being a connection surface between the electrical wire 301 and a connection target so as to envelop the electrical wire 301.

The diameter of the electrical wire 301 is not specially limited, and is set to approximately 20 mm in the third embodiment. The electrical wire 301 is shown as a solid wire in FIG. 14, but may be a stranded wire that a plurality of aluminum wires is stranded. Moreover, the electrical wire 301 may be covered with a jacket or the like in an area other than the end.

The connection layer 302 is a layer having a thickness of approximately 1 to 2 mm, the layer being formed of a metal or alloy having a lower ionization tendency than aluminum metal forming the electrical wire 301, and electrical conductivity equal to that of aluminum metal or higher. The connection layer 302 is provided to prevent the formation of an oxide film on the side surface in the vicinity of the end of the electrical wire 301, the end forming a connection surface, and suppress a decrease in electrical connectivity between the electrical wire 301 and a connection target. Therefore, it is sufficient if the width of the connection layer 302 (the size in a lengthwise direction of the electrical wire 301) is equal to a contact area with the connection target or more. Moreover, specific examples of a material of the connection layer 302 include copper (Cu) or an alloy containing copper, silver (Ag) or an alloy containing silver, and gold (Au) or an alloy containing gold, and copper is used in the third embodiment. In FIG. 14, the connection layer 302 is placed in the vicinity of the end of the electrical wire 301; however, the connection layer 302 may be placed such that an end face of the connection layer 302 coincides with an end face of the electrical wire 301.

Such an end structure 300 of the electrical wire is formed as follows. Firstly, a preparation is made to form the connection layer 302 at the end of the electrical wire 301. For example, if the electrical wire 301 is a bare wire, it is desirable that the end is subjected to grinding and the like to remove a surface oxide film. Moreover, if the electrical wire 301 is an insulated wire, a cladding material of the end is removed in advance.

Next, a copper powder being the material is accelerated to high velocities to be sprayed and deposited on the side surface in the vicinity of the end of the electrical wire 301 while in the solid state, and accordingly the connection layer 302 is formed. Specifically, similarly to FIG. 12, in the film deposition apparatus 5, the electrical wire 301 is set on the holder 62, and the mask 72 is placed such that the opening 72a faces the vicinity of the end of the electrical wire 301. A copper powder is then charged as the material of the connection layer 302 into the powder feed unit 20, and a film is deposited while the holder 62 is being rotated. Consequently, copper deposits on the side surface in the vicinity of the end of the electrical wire 301 to form the copper connection layer 302. After the end of the film deposition, the end of the electrical wire 301, which protrudes from the connection layer 302, may be cut to a desired length, or may be cut or ground such that the end face of the connection layer 302 coincides with the end face of the electrical wire 301.

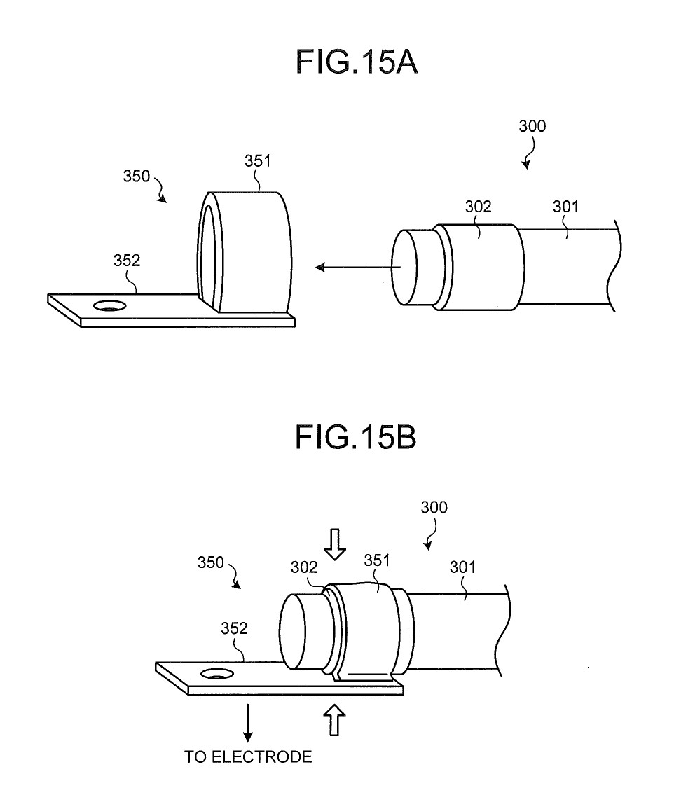

The electrical wire having such an end structure 300 is used as follows. That is, as illustrated in FIG. 15A, a general connection member 350 formed of copper or the like, including an electrode connection unit 351 and a fastening unit 352, is prepared to insert a part of the connection layer 302 of the electrical wire into the electrode connection unit 351. As illustrated in FIG. 15B, the electrode connection unit 351 is then crimped to electrically and mechanically connect the connection layer 302 and the electrode connection unit 351. Furthermore, the fastening unit 352 of the connection member 350 to which the electrical wire 301 has been fastened in this manner is connected by a bolt, soldering, or the like to an electrode of a desired facility or apparatus.

As described above, according to the third embodiment, because the connection layer 302 of copper or the like is formed in the vicinity of the end of the aluminum metal electrical wire 301, it is possible to suppress a decrease in electrical conductivity at the interface with a connection target. Moreover, the connection layer 302 is formed by cold spray, and accordingly is a very compact layer in strong contact with the lower layer. Therefore, it is possible to suppress a decrease in electrical conductivity also at the interface between the electrical wire 301 and the connection layer 302, and in the connection layer 302. Hence, the use of such an end structure makes it possible to connect an aluminum metal electrical wire to a general electrode or connection member formed of copper or the like with excellent electrical connectivity.

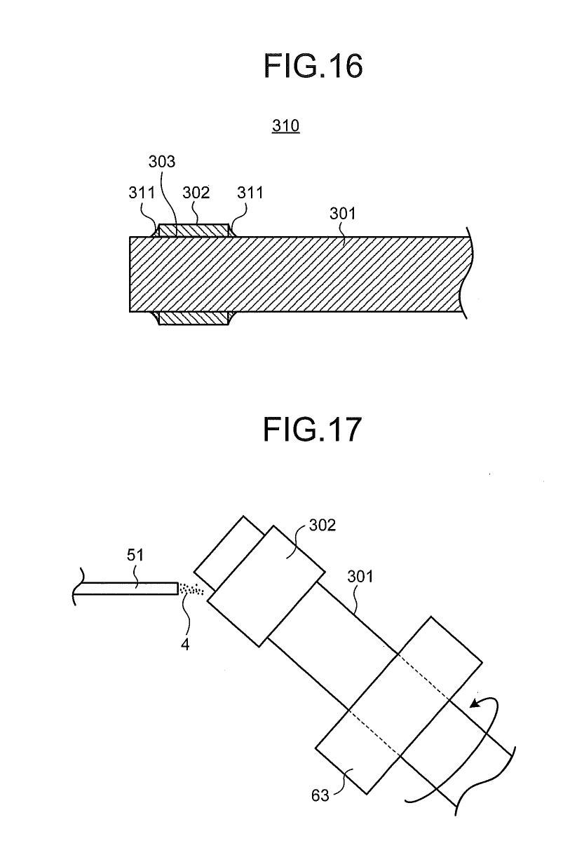

Next, a description will be given of Modification 1 of the conductive member according to the third embodiment. FIG. 16 is a cross-sectional view illustrating a conductive member according to Modification 1.

An end structure 310 of the electrical wire being Modification 1 includes a coating layer 311 formed so as to cover the perimeter of an interface 303 between the electrical wire 301 and the connection layer 302. The other configurations are similar to those illustrated in FIG. 14.

As described above, if aluminum metal and copper are left in direct contact, electrolytic corrosion may occur. Therefore, in Modification 1, the coating layer 311 covers the perimeter of the interface 303 between the electrical wire 301 and the connection layer 302 to shield the interface 303 from the ambient air. It is sufficient if the thickness of the coating layer 311 is, for example, approximately 50 μm or more.

Used as a material of the coating layer 311 is a metal or alloy having a lower ionization tendency than the electrical wire 301 and a higher ionization tendency than the connection layer 302, such as zinc, nickel and tin. Alternatively, a metal or alloy that resists electrolytic corrosion by forming a compact oxide film on a surface, such as titanium, may be used.

Moreover, it is desirable to form the coating layer 311 by cold spray. Specifically, in the film deposition apparatus 5, a small-diameter nozzle 51 and a holder 63, which are illustrated in FIG. 17, are placed, respectively, instead of the nozzle 50 and the holder 60. The holder 63 is a rotatable holder, and its relative position to the small-diameter nozzle 51 is adjusted such that the rotation axis obliquely intersects with the injection direction of the small-diameter nozzle 51. The electrical wire 301 on which the connection layer 302 has been formed is set on the holder 63 to adjust alignment such that a boundary area between the electrical wire 301 and the connection layer 302 faces an injection port of the small-diameter nozzle 51. For example, a tin powder is then charged as a material of the coating layer 211 into the powder feed unit 20, and film deposition starts by rotating the holder 63. Consequently, the powder 4 is jetted from the small-diameter nozzle 51 to form the tin coating layer 311 that covers the perimeter of the interface 303.

In this manner, according to cold spray, it is possible to form a compact coating at a desired position. Accordingly, it becomes possible to cover only the perimeter of the interface 303 without exerting an influence on a surface of the connection layer 302 to be connected to an electrode, connection member, or the like.

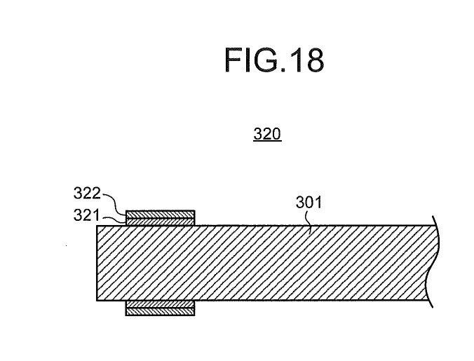

Next, a description will be given of Modification 2 of the conductive member according to the third embodiment. FIG. 18 is a cross-sectional view illustrating a conductive member according to Modification 2.

An end structure 320 of the electrical wire being Modification 2 includes a middle layer 321 formed on the side surface in the vicinity of the end of the electrical wire 301 so as to envelop the electrical wire 301, and a connection layer 322 formed on the middle layer 321. The other configurations are similar to those illustrated in FIG. 14.

Similarly to the third embodiment, the connection layer 322 is provided to prevent the formation of an oxide film on a connection surface of the electrical wire 301 and suppress a decrease in electrical connectivity to a connection target. On the other hand, the middle layer 321 is a layer having a thickness of approximately 1 mm, which is formed to suppress electrolytic corrosion between the aluminum electrical wire 301 and the copper connection layer 322.

Used as a material of the middle layer 321 may be a metal or alloy having a lower ionization tendency than the electrical wire 301 and a higher ionization tendency than the connection layer 322, such as zinc, nickel, and tin, or may be a metal or alloy that resists electrolytic corrosion due to the formation of a compact oxide film, such as titanium.

Such an end structure 320 of the electrical wire is formed by cold spray. Specifically, in the film deposition apparatus 5, firstly, the electrical wire 301 is set on the holder 62, and the mask 71 is placed, similarly to FIG. 12. For example, a tin powder is then charged as a material of the middle layer into the powder feed unit 20, and a film is deposited while the holder 62 is being rotated; accordingly, the middle layer 321 forming the connection surface is deposited on the side surface of the electrical wire 301. Next, the contents of the powder feed unit 20 are replaced with a copper powder, and a film is deposited while the holder 62 is being rotated; accordingly, the connection layer 322 is formed on the middle layer 321.

According to such cold spray, it is possible to form a compact film in close contact with the lower layer. Accordingly, electrical resistance is not significantly increased at the interface between the electrical wire 301 and the middle layer 321, in the middle layer 321, and at the interface between the middle layer 321 and the connection layer 322, either, and it is possible to secure excellent electrical conductivity.

Next, a description will be given of Modification 3 of the conductive member according to the third embodiment. In the third embodiment, the connection layer 302 is formed only on the side surface of the electrical wire 301; however, the connection layer 302 may be formed also on the end face of the electrical wire 301. In this case, a powder (copper or the like) being the material of the connection layer 302 is successively sprayed on the end side surface and the end face of the electrical wire 301 to form a coating. Alternatively, if the electrical wire 301 has a small diameter, a powder of the material of the connection layer 302 may be sprayed on the end area of the electrical wire 301 to simultaneously cover the side surface and the end face. In this modification, the number of areas where the interface between the electrical wire 301 and the connection layer 302 is exposed is one; accordingly, a coating layer for prevention of electrolytic corrosion (refer to Modification 1) is formed only this one place.

### REFERENCE SIGNS LIST

1, 4 Powder
2 Substrate
3 Film
5 Film deposition apparatus
10 Gus introduction tube
11, 12 Valve
20 Powder feed unit
21 Powder feed tube
30 Heater
31 Tube for gas
40 Chamber
50 Nozzle
51 Small-diameter nozzle
60, 61, 62, 63 Holder
71, 72 Mask
71a, 72a Opening
100, 110, 120, 160, 250, 350 Connection member
101, 251, 351 Electrical wire connection unit
102, 252, 352 Fastening unit
103, 122, 203, 223, 302, 322 Connection layer
104 Insertion hole
105 Connection surface
106, 204, 303 Interface
111, 211, 311 Coating layer
121, 221, 321 Middle layer
150, 170 Electrical wire
200, 210, 220, 300, 310, 320 End structure of the electrical wire
201, 301 Electrical wire
202 End face

1. A conductive member comprising:
a base formed of aluminum (Al) or an alloy containing aluminum, the base being provided with a connection surface to be connected to another member; and
a connection layer formed on the base by accelerating a powder of a metal or alloy, which has a lower ionization tendency than the base and has electrical conductivity equal to that of the base or higher, together with gas, and spraying and depositing the powder in a solid state on the connection surface.

2. The conductive member according to claim 1, wherein the connection layer is formed of any one of metals of copper (Cu), silver (Ag), and gold (Au), or an alloy containing any one of the metals.

3. The conductive member according to claim 2, further comprising a coating layer formed around a perimeter of an interface between the base and the connection layer by accelerating a powder of any one of metals of nickel (Ni), zinc (Zn), tin (Sn), and titanium (Ti), or of an alloy containing any one of the metals together with gas, and spraying and depositing the powder in a solid state around the perimeter of the interface.

4. The conductive member according to claim 2, wherein the base includes a middle layer where a powder of any one of metals of nickel (Ni), zinc (Zn), tin (Sn), and titanium (Ti), or of an alloy containing any one of the metals is accelerated together with gas to be sprayed and deposited on the aluminum or aluminum alloy while in a solid state, the middle layer forming the connection surface.

5. The conductive member according to claim 1, wherein the base includes:
an electrical wire connection unit to which an electrical wire is connected, and
a fastening unit connected to the electrical wire connection unit and provided with the connection surface.

6. The conductive member according to claim 1, wherein the base is an electrical wire whose own end face is set as the connection surface.

7. The conductive member according to claim 1, wherein the base is an electrical wire whose own end side surface is set as the connection surface.

8. A method of manufacturing a conductive member, comprising:
a base forming step of forming a base formed of aluminum (Al) or an alloy containing aluminum, the base including a connection surface to be connected to another member; and
a connection layer forming step of forming a connection layer on the base by accelerating a powder of a metal or alloy, which has a lower ionization tendency than the base and has electrical conductivity equal to that of the base or higher, together with gas, and spraying and depositing the powder in a solid state on the connection surface.

9. The method of manufacturing a conductive member according to claim 8, wherein the powder comprises any one of metals of copper (Cu), silver (Ag), and gold (Au), or an alloy containing any one of the metals.

10. The method of manufacturing a conductive member according to claim 9, further comprising a coating layer forming step of forming a coating layer around a perimeter of an interface between the base and the connection layer by accelerating a powder of any one of metals of nickel (Ni), zinc (Zn), tin (Sn), and titanium (Ti), or of an alloy containing any one of the metals together with gas, and spraying and depositing the powder in a solid state around the perimeter of the interface.

11. The method of manufacturing a conductive member according to claim 9, wherein the base forming step includes depositing a middle layer forming the connection surface by accelerating a powder of any one of metals of nickel (Ni), zinc (Zn), tin (Sn), and titanium (Ti), or of an alloy containing any one of the metals together with gas, and spraying the powder in a solid state on the aluminum or aluminum alloy.
